(19) United States
(12) Patent Application Publication
(10) Pub. No.: US 2026/0161269 A1
(43) Pub. Date: Jun. 11, 2026

(54) PAGE INTERACTION METHOD AND RELATED PRODUCTS THEREOF

(71) Applicants: Shenzhen Xiyin Information Technology Co., Ltd., Guangdong (CN); Nanjing Xiyin Ecommerce Co., Ltd., Jiangsu (CN); Guangzhou Xiyin International Import and Export Co., Ltd., Guangdong (CN)

(72) Inventor: YIHAO CHEN, Guangdong (CN)

(21) Appl. No.: 19/250,778

(22) Filed: Jun. 26, 2025

(30) Foreign Application Priority Data
Dec. 9, 2024 (CN) 202411815516.1

(51) Int. Cl. G06F 3/0483; G06F 3/0487; G06F 9/451

(52) U.S. Cl. CPC G06F 3/0483; G06F 3/0487; G06F 9/451

(57) ABSTRACT

A page interaction method includes performing, in response to a click instruction input by a user in a first scene module in a real-time application interface, an interactive operation corresponding to the click instruction, restoring the real-time application interface in response to stop information of the interactive operation, and if a second scene module is present in the real-time application interface and positioned above the first scene module, moving the first scene module to a top of the real-time application interface.

### CROSS-REFERENCE TO RELATED APPLICATION AND CLAIM OF PRIORITY

This application claims the benefit under 35 USC § 119 of Chinese Patent Application No. 202411815516.1 filed on Dec. 9, 2024 in the China Intellectual Property Office, the entire disclosure of which is incorporated herein by reference for all purposes.

### BACKGROUND

### 1. Technical Field

The present application generally relates to the technical field of internet interaction. More specifically, the present application relates to a page interaction method and related products thereof.

### 2. Background Art

Upon an input operation in an interface of an App client by a user, the App client sends related data to a product server which may store the related data or send feedback data in response to the related data back to the App client, and then the App client presents a related interface to the user for viewing.

For contents swiftly stroked away by the user in the APP client, it is very likely that these contents will not provide any browsing value to the user. In contrast, if the user clicks some page links or operation controls, it may indicate that the display contents corresponding to the page links or operation controls are of interest to the user. If exposure of such contents of interest to the user can be actively increased, it may be beneficial to improve the user experience.

In view of this, there is an urgent need to provide a page interaction method which can increase exposure of the content of interest clicked by the user, and thereby improve the use experience of the user.

### SUMMARY

To address at least one or more of the above technical problems, the present application proposes, in various aspects, a page interaction method and related products thereof. The page interaction method can increase exposure of the content of interest clicked by the user, and thereby improve the use experience of the user.

In a first aspect, the present application provides a page interaction method, including: performing, in response to a click instruction input by a user in a first scene module in a real-time application interface, an interactive operation corresponding to the click instruction; restoring the real-time application interface in response to stop information of the interactive operation; and if a second scene module is present in the real-time application interface and positioned above the first scene module, moving the first scene module to a top of the real-time application interface.

In some embodiments, performing the interactive operation corresponding to the click instruction includes: if the click instruction is an instruction for clicking a page link, performing a link browsing operation.

In some embodiments, restoring the real-time application interface in response to stop information of the interactive operation includes: restoring the real-time application interface in response to stop information of the link browsing operation.

In some embodiments, the stop information includes page return information; and wherein restoring the real-time application interface in response to stop information of the link browsing operation includes: restoring the real-time application interface in response to the page return information received during the link browsing operation.

In some embodiments, performing the interactive operation corresponding to the click instruction includes: if the click instruction is an instruction for clicking an operation control, performing an application function operation.

In some embodiments, restoring the real-time application interface in response to stop information of the interactive operation includes: restoring the real-time application interface in response to stop information of the application function operation.

In some embodiments, the stop information includes function completion information and function suspension information; and wherein restoring the real-time application interface in response to stop information of the application function operation includes: restoring the real-time application interface in response to the function completion information or the function suspension information of the application function operation.

In some embodiments, after restoring the real-time application interface, the method further includes: if the first scene module is at the top of the real-time application interface, keeping the first scene module at the top of the real-time application interface.

In some embodiments, after restoring the real-time application interface, the method further includes: displaying a page restore button in the first scene module; and restoring the first scene module to a position before movement in response to a page restore instruction generated by clicking the page restore button by the user, to re-display the second scene module in the real-time application interface.

In some embodiments, before performing, in response to the click instruction input by the user in the first scene module in the real-time application interface, the interactive operation corresponding to the click instruction, the method further includes: enabling a module anchor-to-top function in response to an anchor enabling instruction generated by clicking an anchor function button in the real-time application interface by the user.

In some embodiments, after moving the first scene module to the top of the real-time application interface, the method further includes: performing, in response to a click instruction input by a user in a second scene module in the real-time application interface, an interactive operation corresponding to the click instruction; restoring the real-time application interface in response to stop information of the interactive operation; and if more interactive operations are performed in the first scene module than in the second scene module, keeping the first scene module at the top of the real-time application interface.

In a second aspect, the present application provides a device for page interaction, including: a memory; and at least one processor configured to: perform, in response to a click instruction input by a user in a first scene module in a real-time application interface, an interactive operation corresponding to the click instruction; restore the real-time application interface in response to stop information of the interactive operation; and if a second scene module is present in the real-time application interface and positioned above the first scene module, move the first scene module to a top of the real-time application interface.

In a third aspect, the present application provides a non-transitory machine-readable medium having a program code for page interaction stored thereon which, when executed by at least one processor, directs the at least one processor to perform the operations of: performing, in response to a click instruction input by a user in a first scene module in a real-time application interface, an interactive operation corresponding to the click instruction; restoring the real-time application interface in response to stop information of the interactive operation; and if a second scene module is present in the real-time application interface and positioned above the first scene module, moving the first scene module to a top of the real-time application interface.

The technical solutions provided in the present application may achieve the following beneficial effects:

According to the page interaction method and the related products thereof provided in the present application, in response to a click instruction input by a user in a first scene module in a real-time application interface, an interactive operation corresponding to the click instruction is performed; in response to stop information of the interactive operation, the real-time application interface is restored; and then, if a second scene module is present in the real-time application interface and positioned above the first scene module, the first scene module is moved to a top of the real-time application interface, so that the first scene module, which is clicked by the user (suggesting that the user is interested) is pushed to the top of the real-time application interface, i.e., the most notable position, which increases exposure of the first scene module, and thereby helps to deepen the interaction with the user in the first scene module.

Generally speaking, the present application can increase exposure of the content of interest clicked by the user, and thereby improve the use experience of the user.

### BRIEF DESCRIPTION OF THE DRAWINGS

The above and other objectives, features and advantages of exemplary implementations of the present application will become readily apparent from the following detailed description, which proceeds with reference to the accompanying drawings. In the accompanying drawings, several implementations of the present application are illustrated by way of example but not limitation, and like or corresponding reference numerals indicate like or corresponding parts, in which:

FIG. 1 shows an exemplary flowchart of a page interaction method according to some embodiments of the present application;

FIG. 2 shows an exemplary flowchart of a page interaction method according to some other embodiments of the present application;

FIG. 3 shows an exemplary flowchart of a page interaction method according to still other embodiments of the present application;

FIG. 4 shows a diagram of a first example of a real-time application interface in a page interaction method according to an embodiment of the present application;

FIG. 5 shows a diagram of the first example of the real-time application interface with a first scene module fixed at the top in a page interaction method according to an embodiment of the present application;

FIG. 6 shows a diagram of a second example of a real-time application interface in a page interaction method according to an embodiment of the present application;

FIG. 7 shows a diagram of the second example of the real-time application interface with a first scene module fixed at the top in a page interaction method according to an embodiment of the present application; and

FIG. 8 shows a block diagram of hardware configuration of a device for page interaction that can implement the page interaction method according to an embodiment of the present application.

### DETAILED DESCRIPTION

The technical solutions in the embodiments of the present application will be clearly and completely described below with reference to the accompanying drawings in the embodiments of the present application. Apparently, the described embodiments are only part, but not all, of the embodiments of the present application. For simplicity and clarity of illustration, where considered appropriate, reference numerals may be repeated among the figures to indicate corresponding or analogous elements. In addition, the present application sets forth numerous specific details to provide a thorough understanding of the embodiments described herein. However, it will be understood by one of ordinary skill in the art that the embodiments described herein may be practiced without these specific details. In other instances, well-known methods, procedures, and components have not been described in detail so as not to obscure the embodiments described herein. Moreover, the description should not be taken as limiting the scope of the embodiments described herein. All other embodiments obtained by those skilled in the art based on the embodiments in the present application without any creative labor belong to the protection scope of the present application.

It should be understood that the possible terms “first” or “second” or the like in the claims, description and drawings disclosed in the present application are used to distinguish different objects, and are not used to describe a particular order. The terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular embodiments only, and is not intended to limit the present application. As used in the specification and claims of the present application, the singular forms “a”, “an” and “the” are intended to include the plural forms as well, unless the context clearly indicates otherwise. It should be further understood that the term “and/or” as used in the description and claims of the present application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

For contents swiftly stroked away by the user in the APP client, it is very likely that these contents will not provide any browsing value to the user. In contrast, if the user clicks some page links or operation controls, it may indicate that the display contents corresponding to the page links or operation controls are of interest to the user. If exposure of such contents of interest to the user can be actively increased, it may be beneficial to improve the user experience.

In view of this, there is an urgent need to provide a page interaction method which can increase exposure of the content of interest clicked by the user, and thereby improve the use experience of the user.

Specific implementations of the present application will be described in detail below with reference to the accompanying drawings.

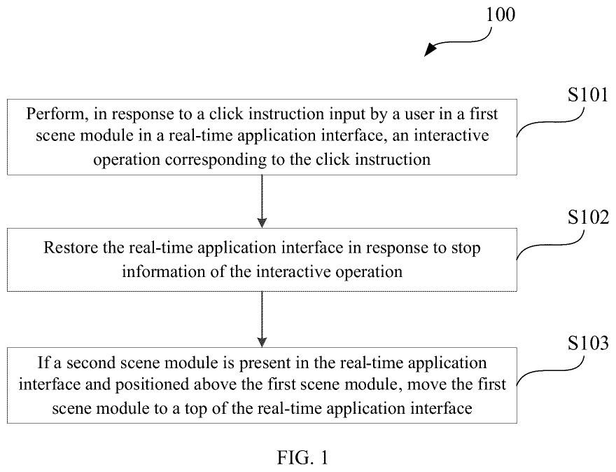

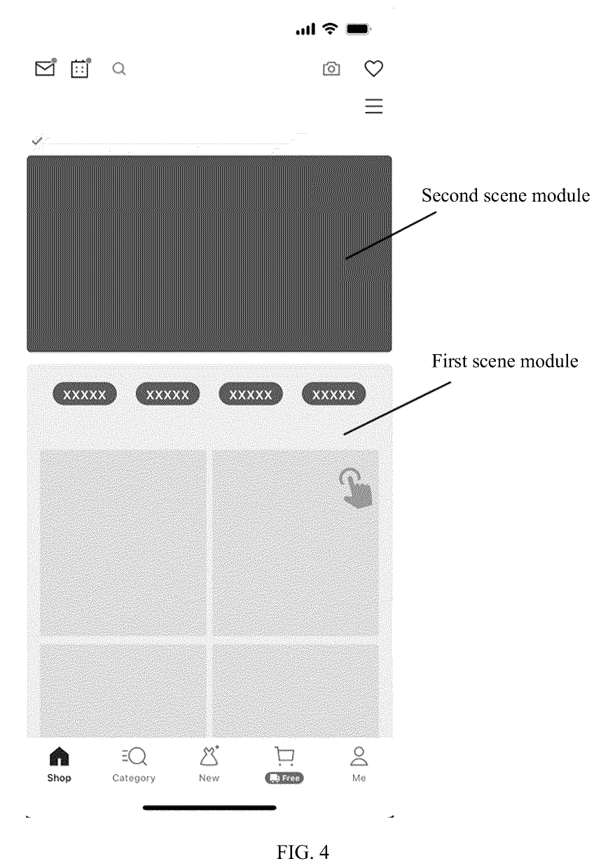

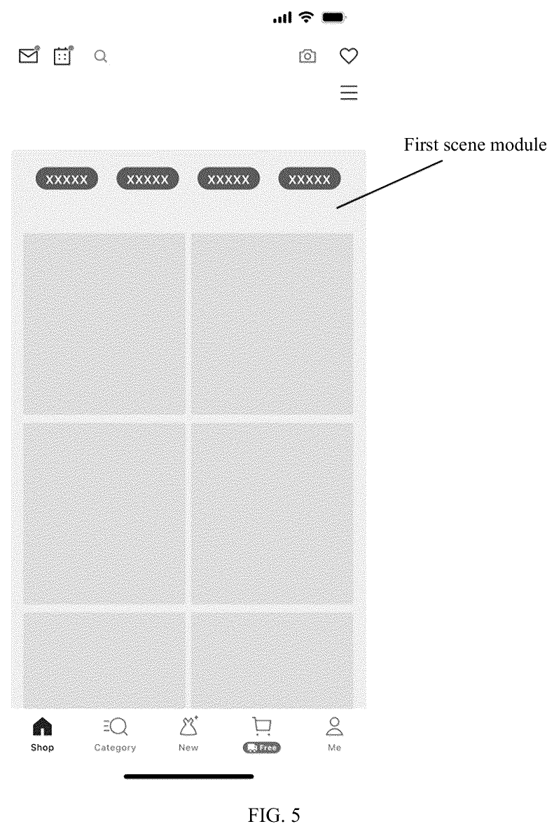

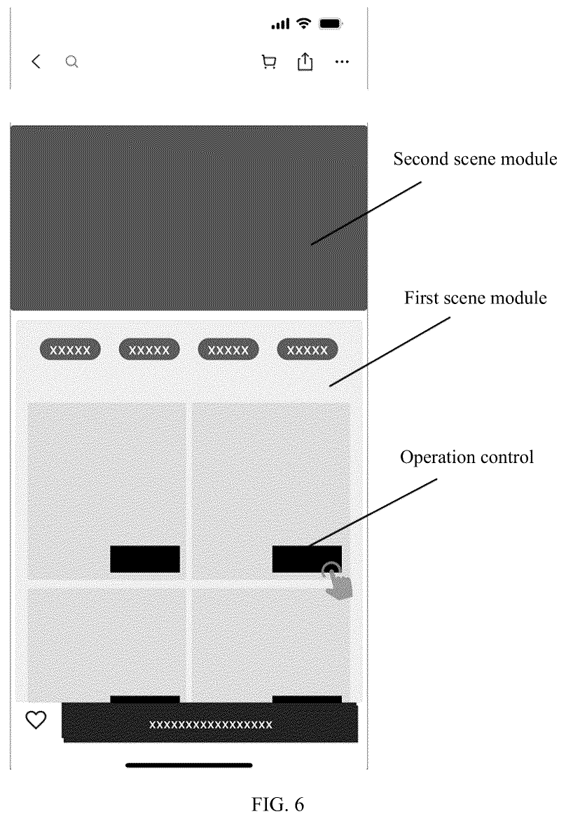

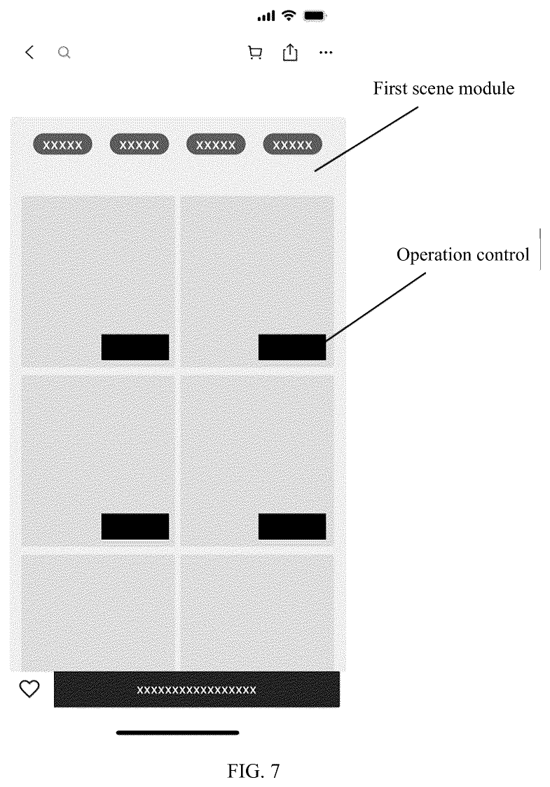

FIG. 1 shows an exemplary flowchart 100 of a page interaction method according to some embodiments of the present application, FIG. 4 shows a diagram of a first example of a real-time application interface in a page interaction method according to an embodiment of the present application, FIG. 5 shows a diagram of the first example of the real-time application interface with a first scene module fixed at the top in a page interaction method according to an embodiment of the present application, FIG. 6 shows a diagram of a second example of a real-time application interface in a page interaction method according to an embodiment of the present application, and FIG. 7 shows a diagram of the second example of the real-time application interface with a first scene module fixed at the top in a page interaction method according to an embodiment of the present application. Referring to FIGS. 1 and 4 to 7, a page interaction method according to an embodiment of the present application may include the following steps S101 to S103.

At step S101, in response to a click instruction input by a user in a first scene module in a real-time application interface, an interactive operation corresponding to the click instruction is performed. In an embodiment of the present application, a user may click in a first scene module of a real-time application interface to complete input of a click instruction. As shown in FIG. 4, the clicked position may be, for example, a page link for entering an item detail page, or, as shown in FIG. 6, an operation control for performing an add-to-favorite operation. It will be understood that different click instructions are input by clicking different positions, and correspond to different interactive operations to be performed. In practical applications, the specific instruction content of a click instruction may be determined according to the practical application conditions, and then an interactive operation corresponding to the click instruction is performed, which is not limited in any manner in the present application.

At step S102, in response to stop information of the interactive operation, the real-time application interface is restored. In an embodiment of the present application, the stop information refers to information generated when the interactive operation is stopped. The stop information may be input by a user, for example, page return information input by a user, so that the interactive operation of page browsing can be stopped; or the stop information may be information generated when a function is suspended or completed, indicating that a functional interactive operation such as an add-to-favorite operation is stopped. It will be understood that the stop information may be generated in various manners and have various forms, which may be determined in practical applications according to the practical application conditions, and is not limited in any manner in the present application.

At step S103, if a second scene module is present in the real-time application interface and positioned above the first scene module, the first scene module is moved to a top of the real-time application interface. As shown in FIGS. 4 and 6, if a second scene module is present in the real-time application interface and positioned above the first scene module, it indicates that the first scene module of interest by the user is not fixed to the top, and the exposure of the first scene module is not notable enough, so that the first scene module is moved to the top of the real-time application interface, as shown in FIGS. 5 and 7, to increase exposure of the first scene module. It will be understood that if the first scene module has already been positioned at the top of the real-time application interface, the first scene module is kept at the top of the real-time application interface.

According to the embodiment of the present application, in response to a click instruction input by a user in a first scene module in a real-time application interface, an interactive operation corresponding to the click instruction is performed; in response to stop information of the interactive operation, the real-time application interface is restored; and then, if a second scene module is present in the real-time application interface and positioned above the first scene module, the first scene module is moved to a top of the real-time application interface, so that the first scene module, which is clicked by the user (suggesting that the user is interested) is pushed to the top of the real-time application interface, i.e., the most notable position, which increases exposure of the first scene module, and thereby helps to deepen the interaction with the user in the first scene module. Generally speaking, the present application can increase exposure of the content of interest clicked by the user, and thereby improve the use experience of the user.

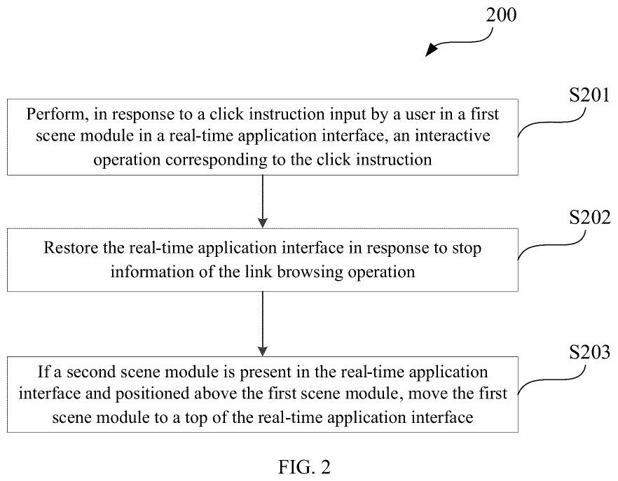

In some embodiments, the interactive operation may include a link browsing operation. The specific process in the case where the interactive operation is a link browsing operation will be described in detail below with reference to FIG. 2. FIG. 2 shows an exemplary flowchart 200 of a page interaction method according to some other embodiments of the present application. Referring to FIG. 2, a page interaction method according to an embodiment of the present application may include the following steps S201 to S203.

At step S201, performing, in response to a click instruction input by a user in a first scene module in a real-time application interface, an interactive operation corresponding to the click instruction. In an embodiment of the present application, if the click instruction is an instruction for clicking a page link, a link browsing operation is performed. The page link refers to a link for jumping to a next page, such as the item page link shown in FIG. 4 which may be clicked to jump to a corresponding detailed item page, so that a link browsing operation can be performed, and a new page can be browsed.

In some application scenarios, a module anchor-to-top function may be enabled in response to an anchor enabling instruction generated by clicking an anchor function button in the real-time application interface by the user, so that the user can conveniently enable or disable the module anchor-to-top function according to his/her usage habits or usage requirements. It will be understood that when the module anchor-to-top function is disabled, the scene module will not be automatically moved to the top of the real-time application interface after the interactive operation.

At step S202, the real-time application interface is restored in response to stop information of the link browsing operation. In an embodiment of the present application, the stop information may include page return information, and it will be understood that the page return information may be actively input by a user, which means that the user has finished browsing the jump page corresponding to the page link, and wants to return to the real-time application interface now. Further, the real-time application interface may be restored in response to the page return information received during the link browsing operation.

At step S203, if a second scene module is present in the real-time application interface and positioned above the first scene module, the first scene module is moved to a top of the real-time application interface. In an embodiment of the present application, the content of step S203 is substantially the same as the content of step S103, and thus is not repeated here.

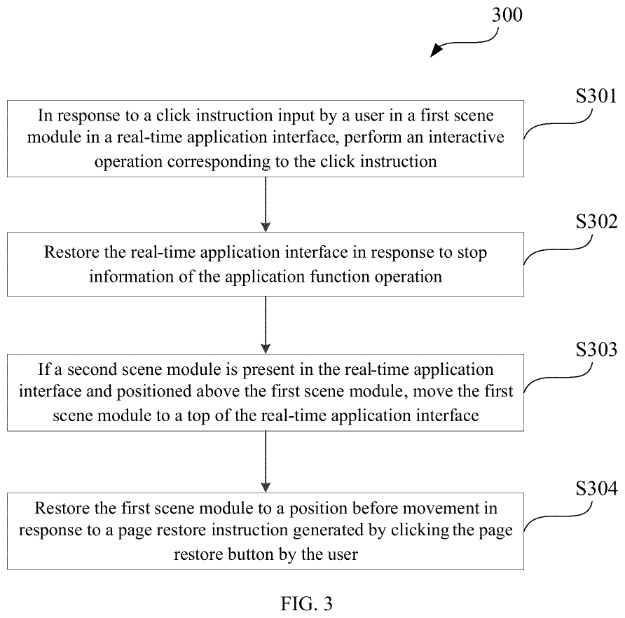

In some embodiments, the interactive operation may further include an application function operation. The specific process in the case where the interactive operation is an application function operation will be described in detail below with reference to FIG. 3. FIG. 3 shows an exemplary flowchart 300 of a page interaction method according to still other embodiments of the present application. Referring to FIG. 3, a page interaction method according to an embodiment of the present application may include the following steps S301 to S303.

At step S301, in response to a click instruction input by a user in a first scene module in a real-time application interface, an interactive operation corresponding to the click instruction is performed. In an embodiment of the present application, if the click instruction is an instruction for clicking an operation control, an application function operation is performed. The operation control refers to a control that can enable or trigger a function when clicked, such as the button control shown in FIG. 4 which may be, for example, a favorite button or a cart button, and the like. Accordingly, by clicking the favorite button, a corresponding item may be added into a favorite list, and by clicking the cart button, a corresponding item may be added into a cart list. It will be understood that in practical applications, the specific form and corresponding operation function of the operation control may be determined according to the practical application conditions, which is not limited in any manner in the present application. Therefore, an application function operation can be performed, and the corresponding function can be enabled or triggered.

At step S302, the real-time application interface is restored in response to stop information of the application function operation. In an embodiment of the present application, the stop information may include function completion information and function suspension information. The function completion information refers to information generated when the function is completed, and the function suspension information refers to information generated when the function is suspended during execution. It will be understood that the function completion information may be automatically generated by an application, indicating that execution of the function is completed; and the function suspension information may be automatically generated by an application, indicating that the function may be stopped due to an error in execution, or may be actively input by a user, indicating that the user wants to actively stop execution of the function. Therefore, the real-time application interface may be restored in response to the function completion information or the function suspension information of the application function operation.

At step S303, if a second scene module is present in the real-time application interface and positioned above the first scene module, the first scene module is moved to a top of the real-time application interface. In some application scenarios, after moving the first scene module to the top of the real-time application interface, a user may scroll the screen to re-display the content in the second scene module, and then in response to a click instruction input by the user in a second scene module in the real-time application interface, an interactive operation corresponding to the click instruction is performed, and further in response to stop information of the interactive operation, the real-time application interface is restored. If more interactive operations are performed in the first scene module than in the second scene module, it indicates that the user performs more interactive operations in the first scene module and may be more interested in the content in the first scene module, so that the first scene module may be kept at the top of the real-time application interface when the real-time application interface is restored.

At step S304, the first scene module is restored to a position before movement in response to a page restore instruction generated by clicking the page restore button by the user. In an embodiment of the present application, after moving the first scene module to the top of the real-time application interface, a page restore button may be displayed in the first scene module, and the page restore button may be set to be semi-transparent to avoid affecting the user viewing the content in the first scene module. When the user clicks the page restore button, a page restore instruction is input, so that the first scene module can be restored to the position before movement, to re-display the second scene module in the real-time application interface. Therefore, the user does not need to scroll the phone screen to find the original position, thereby satisfying the usage habits of different users.

Corresponding to the embodiments of the application function implementation method described above, the present application further provides a device for page interaction and corresponding embodiments thereof.

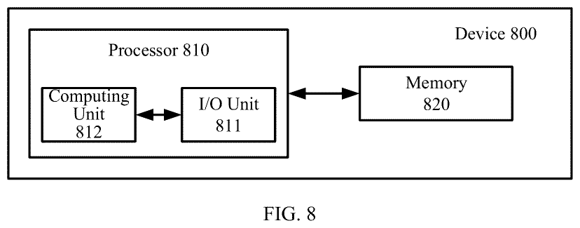

FIG. 8 shows a block diagram of hardware configuration of a device 800 for page interaction that can implement the page interaction method according to an embodiment of the present application. As shown in FIG. 8, the device 800 for page interaction may include a processor 810 and a memory 820. In the device 800 for page interaction of FIG. 8, only constituent elements related to the present embodiment are shown. Therefore, it will be apparent to those of ordinary skill in the art that: the device 800 for page interaction may further include common constituent elements other than those shown in FIG. 8, such as a fixed-point arithmetic unit.

The device 800 for page interaction may correspond to a computing device having various processing functions, such as functions for generation, training or learning of a neural network, for quantizing a floating point type neural network to a fixed point type neural network, or for retraining a neural network. For example, the device 800 for page interaction may be implemented as various types of devices, such as a personal computer (PC), a server device, a mobile device, and so on.

The processor 810 controls all functions of the device 800 for page interaction. For example, the processor 810 controls all functions of the device 800 for page interaction by executing programs stored on the memory 820 in the device 800 for page interaction. The processor 810 may be implemented by a central processing unit (CPU), a graphics processing unit (GPU), an application processor (AP), an intelligent processing unit (IPU), and the like provided in the device 800 for page interaction. However, the present application is not limited thereto.

In some embodiments, the processor 810 may include an input/output (I/O) unit 811 and a computing unit 812. The I/O unit 811 may be configured to receive various types of data, such as a feature profile issued by a server. Illustratively, the computing unit 812 may be configured to collect real-time feature data based on the feature profile received via the I/O unit 811, store the real-time feature data in a client database, and, in response to a data transfer instruction sent from the server, report and feedback the real-time feature data to the server, so that the server can determine a processing policy based on the real-time feature data. The real-time feature data may be output from the I/O unit 811, for example. The output data may be provided to the memory 820 for reading by other devices (not shown), or may be provided directly to other devices for use.

The memory 820 is hardware for storing various data processed in the device 800 for page interaction. For example, the memory 820 may store processed data and data to be processed in the device 800 for page interaction. The memory 820 may store data sets processed or to be processed by the processor 810 involved in steps of the page interaction method, such as a feature profile issued by a server and the like. Further, the memory 820 may store applications to be driven by the device 800 for page interaction, drivers, and the like. For example: the memory 820 may store various programs related to a page interaction method to be executed by the processor 810. The memory 820 may be a DRAM, but the present application is not limited thereto. The memory 820 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash, phase-change RAM (PRAM), a magnetic RAM (MRAM), a resistive RAM (RRAM), a ferroelectric RAM (FRAM), or the like. The volatile memory may include a dynamic RAM (DRAM), a static RAM (SRAM), a synchronous DRAM (SDRAM), a PRAM, an MRAM, an RRAM, a ferroelectric RAM (FeRAM), or the like. In one embodiment, the memory 820 may include at least one of a hard disk drive (HDD), a solid state drive (SSD), a compact flash (CF), a secure digital (SD) card, a Micro-SD card, a Mini-SD card, an xD card, a cache, or a memory stick.

In summary, specific functions implemented by the memory 820 and the processor 810 of the device 800 for page interaction provided in the implementations of the present disclosure may be explained in comparison with the foregoing implementations in the description of the present disclosure, and can achieve the technical effects of the foregoing implementations, and therefore, no further description is provided here.

In this implementation, the processor 810 may be implemented in any suitable manner. For example, the processor 810 may take the form of, for example, a microprocessor or processor and a computer-readable medium that stores a computer-readable program code (e.g., software or firmware) executable by the (micro) processor, a logic gate, a switch, an application specific integrated circuit (ASIC), a programmable logic controller, an embedded microcontroller, or the like.

It will also be appreciated that any module, unit, component, server, computer, terminal or device exemplified herein that executes instructions may include or otherwise have access to computer-readable media such as storage media, computer storage media, or data storage devices (removable and/or non-removable) such as, for example, magnetic disks, optical disks or tape. The computer storage medium may include volatile and non-volatile, removable and non-removable media implemented in any method or technology for storage of information, such as computer-readable instructions, data structures, program modules, or the like.

The foregoing may be better understood in light of the following clauses:

Clause A1. A page interaction method, including: performing, in response to a click instruction input by a user in a first scene module in a real-time application interface, an interactive operation corresponding to the click instruction; restoring the real-time application interface in response to stop information of the interactive operation; and if a second scene module is present in the real-time application interface and positioned above the first scene module, moving the first scene module to a top of the real-time application interface.

Clause A2. The page interaction method of clause A1, wherein performing the interactive operation corresponding to the click instruction includes: if the click instruction is an instruction for clicking a page link, performing a link browsing operation.

Clause A3. The page interaction method of clause A2, wherein restoring the real-time application interface in response to stop information of the interactive operation includes: restoring the real-time application interface in response to stop information of the link browsing operation.

Clause A4. The page interaction method of clause A3, wherein the stop information includes page return information; and wherein restoring the real-time application interface in response to stop information of the link browsing operation includes:
restoring the real-time application interface in response to the page return information received during the link browsing operation.

Clause A5. The page interaction method of clause A1, wherein performing the interactive operation corresponding to the click instruction includes: if the click instruction is an instruction for clicking an operation control, performing an application function operation.

Clause A6. The page interaction method of clause A5, wherein restoring the real-time application interface in response to stop information of the interactive operation includes: restoring the real-time application interface in response to stop information of the application function operation.

Clause A7. The page interaction method of clause A6, wherein the stop information includes function completion information and function suspension information; and wherein restoring the real-time application interface in response to stop information of the application function operation includes: restoring the real-time application interface in response to the function completion information or the function suspension information of the application function operation.

Clause A8. The page interaction method of clause A1, wherein after restoring the real-time application interface, the method further includes: if the first scene module is at the top of the real-time application interface, keeping the first scene module at the top of the real-time application interface.

Clause A9. The page interaction method of clause A1, wherein after restoring the real-time application interface, the method further includes: displaying a page restore button in the first scene module; and restoring the first scene module to a position before movement in response to a page restore instruction generated by clicking the page restore button by the user, to re-display the second scene module in the real-time application interface.

Clause A10. The page interaction method of clause A1, wherein before performing, in response to the click instruction input by the user in the first scene module in the real-time application interface, the interactive operation corresponding to the click instruction, the method further includes: enabling a module anchor-to-top function in response to an anchor enabling instruction generated by clicking an anchor function button in the real-time application interface by the user.

Clause A11. The page interaction method of clause A1, wherein after moving the first scene module to the top of the real-time application interface, the method further includes: performing, in response to a click instruction input by a user in a second scene module in the real-time application interface, an interactive operation corresponding to the click instruction; restoring the real-time application interface in response to stop information of the interactive operation; and if more interactive operations are performed in the first scene module than in the second scene module, keeping the first scene module at the top of the real-time application interface.

Clause A12. A device for page interaction, including: a memory; and at least one processor configured to: perform, in response to a click instruction input by a user in a first scene module in a real-time application interface, an interactive operation corresponding to the click instruction; restore the real-time application interface in response to stop information of the interactive operation; and if a second scene module is present in the real-time application interface and positioned above the first scene module, move the first scene module to a top of the real-time application interface.

Clause A13. A non-transitory machine-readable medium having a program code for page interaction stored thereon which, when executed by at least one processor, directs the at least one processor to perform the operations of: performing, in response to a click instruction input by a user in a first scene module in a real-time application interface, an interactive operation corresponding to the click instruction; restoring the real-time application interface in response to stop information of the interactive operation; and if a second scene module is present in the real-time application interface and positioned above the first scene module, moving the first scene module to a top of the real-time application interface.

What is claimed is:

1. A page interaction method comprising:
performing, in response to a click instruction input by a user in a first scene module in a real-time application interface, an interactive operation corresponding to the click instruction;
restoring the real-time application interface in response to stop information of the interactive operation; and
if a second scene module is present in the real-time application interface and positioned above the first scene module, moving the first scene module to a top of the real-time application interface.

2. The page interaction method of claim 1, wherein the performing of the interactive operation comprises:
performing a link browsing operation if the click instruction is an instruction for clicking a page link.

3. The page interaction method of claim 2, wherein the restoring of the real-time application interface comprises:
restoring the real-time application interface in response to stop information of the link browsing operation.

4. The page interaction method of claim 3, wherein the stop information includes page return information; and
wherein the restoring of the real-time application interface comprises:
restoring the real-time application interface in response to the page return information received during the link browsing operation.

5. The page interaction method of claim 1, wherein the performing of the interactive operation comprises:
performing an application function operation if the click instruction is an instruction for clicking an operation control.

6. The page interaction method of claim 5, wherein the restoring of the real-time application interface comprises:
restoring the real-time application interface in response to stop information of the application function operation.

7. The page interaction method of claim 6, wherein the stop information includes function completion information and function suspension information; and
wherein the restoring of the real-time application interface comprises:
restoring the real-time application interface in response to the function completion information or the function suspension information of the application function operation.

8. The page interaction method of claim 1, further comprising:
after restoring the real-time application interface, if the first scene module is at the top of the real-time application interface, keeping the first scene module at the top of the real-time application interface.

9. The page interaction method of claim 1, further comprising:
after restoring the real-time application interface, displaying a page restore button in the first scene module; and
restoring the first scene module to a position before movement in response to a page restore instruction generated by clicking the page restore button by the user, to re-display the second scene module in the real-time application interface.

10. The page interaction method of claim 1, further comprising:
before performing the interactive operation, enabling a module anchor-to-top function in response to an anchor enabling instruction generated by clicking an anchor function button in the real-time application interface by the user.

11. The page interaction method of claim 1, further comprising:
after moving the first scene module to the top of the real-time application interface, performing, in response to a click instruction input by a user in a second scene module in the real-time application interface, an interactive operation corresponding to the click instruction;
restoring the real-time application interface in response to stop information of the interactive operation; and
if more interactive operations are performed in the first scene module than in the second scene module, keeping the first scene module at the top of the real-time application interface.

12. A device for page interaction, comprising:
a memory; and
at least one processor configured to:
perform, in response to a click instruction input by a user in a first scene module in a real-time application interface, an interactive operation corresponding to the click instruction;
restore the real-time application interface in response to stop information of the interactive operation; and
if a second scene module is present in the real-time application interface and positioned above the first scene module, move the first scene module to a top of the real-time application interface.

13. The device of claim 12, wherein the processor is further configured to: after restoring the real-time application interface, if the first scene module is at the top of the real-time application interface, keep the first scene module at the top of the real-time application interface.

14. The device of claim 12, wherein the processor is further configured to: after restoring the real-time application interface,
display a page restore button in the first scene module; and
restore the first scene module to a position before movement in response to a page restore instruction generated by clicking the page restore button by the user, to re-display the second scene module in the real-time application interface.

15. The device of claim 12, wherein the processor is further configured to: before performing, in response to the click instruction input by the user in the first scene module in the real-time application interface, the interactive operation corresponding to the click instruction, enable a module anchor-to-top function in response to an anchor enabling instruction generated by clicking an anchor function button in the real-time application interface by the user.

16. The device of claim 12, wherein the processor is further configured to: after moving the first scene module to the top of the real-time application interface,
perform, in response to a click instruction input by a user in a second scene module in the real-time application interface, an interactive operation corresponding to the click instruction;
restore the real-time application interface in response to stop information of the interactive operation; and
if more interactive operations are performed in the first scene module than in the second scene module, keep the first scene module at the top of the real-time application interface.

17. A non-transitory machine-readable medium having a program code for page interaction stored thereon which, when executed by at least one processor, directs the at least one processor to perform the operations of:
performing, in response to a click instruction input by a user in a first scene module in a real-time application interface, an interactive operation corresponding to the click instruction;
restoring the real-time application interface in response to stop information of the interactive operation; and
if a second scene module is present in the real-time application interface and positioned above the first scene module, moving the first scene module to a top of the real-time application interface.
